(19) United States
(12) Patent Application Publication
(10) Pub. No.: US 2024/0276535 A1
(43) Pub. Date: Aug. 15, 2024

(54) METHOD FOR DYNAMICALLY SWITCHING FREQUENCY BANDS, TERMINAL DEVICE AND NETWORK DEVICE

(71) Applicant: Chicony Electronics Co., Ltd., New Taipei City (TW)

(72) Inventor: Hsuan-Che Chien, New Taipei City (TW)

(73) Assignee: Chicony Electronics Co., Ltd., New Taipei City (TW)

(21) Appl. No.: 18/336,052

(22) Filed: Jun. 16, 2023

(30) Foreign Application Priority Data
Feb. 14, 2023 (TW) 112105169

(51) Int. Cl. H04W 72/542; H04W 72/0453

(52) U.S. Cl. CPC H04W 72/542; H04W 72/0453

(57) ABSTRACT

Disclosed are a method for dynamically switching frequency bands, a terminal device and a network device. The method includes: monitoring a first connection quality between the terminal device and the network device on a first frequency band, the terminal device exchanges data with the network device on the first frequency band based on a wireless network communication protocol; in response to determining that a first connection quality of the first frequency band does not meet a specified quality requirement, requesting the network device to find a second frequency band that meets the specified quality requirement from multiple frequency bands specified by the wireless network communication protocol; and in response to determining that the network device has found the second frequency band that meets the specified quality requirement, re-establishing a connection with the network device on the second frequency band.

### CROSS-REFERENCE TO RELATED APPLICATION

This application claims the priority benefit of Taiwan application serial no. 112105169, filed on Feb. 14, 2023. The entirety of the above-mentioned patent application is hereby incorporated by reference herein and made a part of this specification.

### BACKGROUND

### Technical Field

The present disclosure relates to a network communication technology, and in particular to a method for dynamically switching frequency bands, a terminal device and a network device.

### Description of Related Art

To adapt to change over time, the Institute of Electrical and Electronics Engineers (IEEE) establishes the IEEE 802.11ah standard as a WiFi long-distance solution in response to demands in this era, which is commonly known as WiFi HaLow. This standard not only can use WiFi as the basis for upper-layer communication, but also solve the demand for long-distance transmission, so that developers do not need to rewrite application programs, and it is possible to significantly extend the transmission distance by simply changing the wireless solution to WiFi HaLow.

However, to meet the requirement of long-distance transmission, IEEE 802.11ah adopts the frequency band of Sub-1 GHz, thus making the communication device using IEEE 802.11ah likely to be affected by other communication devices that also adopt Sub-1 GHz frequency band, such as mobile phones and/or devices using LoRa (Long Range), etc.

### SUMMARY

In view of the above issue, the present disclosure provides a method for dynamically switching frequency bands, a terminal device and a network device, which may be used to solve the above technical problems.

An embodiment of the disclosure provides a method for dynamically switching frequency bands, which is adaptable for a terminal device and includes: monitoring a first connection quality between the terminal device and a network device on a first frequency band, the terminal device exchanges data with the network device on the first frequency band based on a wireless network communication protocol; in response to determining that a first connection quality of the first frequency band does not meet a specified quality requirement, requesting the network device to find a second frequency band that meets the specified quality requirement from multiple frequency bands specified by the wireless network communication protocol; and in response to determining that the network device has found the second frequency band that meets the specified quality requirement, re-establishing a connection with the network device on the second frequency band.

An embodiment of the present disclosure provides a terminal device, which includes a communication circuit and a processor. The processor is coupled to the communication circuit and configured to: monitor a first connection quality between the terminal device and a network device on a first frequency band, the terminal device exchanges data with the network device on the first frequency band based on a wireless network communication protocol; in response to determining that a first connection quality of the first frequency band does not meet a specified quality requirement, request the network device to find a second frequency band that meets the specified quality requirement from multiple frequency bands specified by the wireless network communication protocol; and in response to determining that the network device has found the second frequency band that meets the specified quality requirement, re-establish a connection with the network device on the second frequency band.

An embodiment of the disclosure provides a method for dynamically switching frequency bands, which is adaptable for a network device and includes: exchanging data with a terminal device on a first frequency band based on a wireless network communication protocol; in response to the request of the terminal device, finding a second frequency band that meets a specified quality requirement from multiple frequency bands specified by the wireless network communication protocol; and in response to determining that the second frequency band that meets the specified quality requirement has been found, re-establishing a connection with the terminal device on the second frequency band.

An embodiment of the present disclosure provides a network device, which includes a communication circuit and a processor. The processor is coupled to the communication circuit and configured to: exchange data with a terminal device on a first frequency band based on a wireless network communication protocol; in response to the request of the terminal device, find a second frequency band that meets a specified quality requirement from multiple frequency bands specified by the wireless network communication protocol; and in response to determining that the second frequency band that meets the specified quality requirement has been found, re-establish a connection with the terminal device on the second frequency band.

### BRIEF DESCRIPTION OF THE DRAWINGS

FIG. 1 is a schematic diagram of a communication system according to an embodiment of the present disclosure.

FIG. 2 is a flowchart of a method for dynamically switching frequency bands according to an embodiment of the present disclosure.

FIG. 3 is a flowchart of a method for dynamically switching frequency bands performed by a terminal device according to an embodiment of the present disclosure.

### DESCRIPTION OF THE EMBODIMENTS

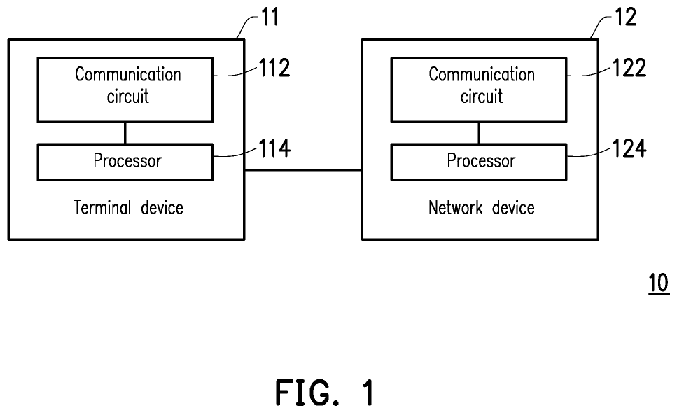

Referring to FIG. 1, which is a schematic diagram of a communication system according to an embodiment of the present disclosure. In FIG. 1, a communication system 10 includes a terminal device 11 and a network device 12.

In different embodiments, the terminal device 11 may be a user equipment (UE), a mobile station, an advanced mobile station (AMS), or a wireless terminal communication device. In addition, the terminal device 11 may be a mobile phone, a smart phone, a personal computer (PC), a notebook PC, a netbook PC, a tablet PC, a television set, a set-top-box, a wireless data modem, a game console, a portable device, or a portable multimedia player, etc.

In different embodiments, the network device 12 is, for example, a wireless network access point (such as an access point applying IEEE 802.11ah), a base station, an enhanced node B (eNodeB), an advanced base station (ABS), a macro-cell base station, a pico-cell base station, or a remote radio head (RRH), etc., but the disclosure is not limited thereto.

As shown in FIG. 1, the terminal device 11 includes a communication circuit 112 and a processor 114. In an embodiment, the communication circuit 12 may include at least a transmitter circuit, a receiver circuit, an analog-to-digital (A/D) converter, a digital-to-analog (D/A) converter, a low noise amplifier (LNA), a mixer, a filter, a matching circuit, a transmission line, a power amplifier (PA), one or more antenna units, a local storage media and so on to provide wireless access functions for the terminal device 11.

In some embodiments, the communication circuit 112 may be a component such as a protocol unit, which is able to support various wireless network communication protocols, such as WiFi HaLow and the like. In other embodiments, the communication circuit 112 may also support global system for mobile communication (GSM), personal handy-phone system (PHS), code division multiple access (CDMA) system, wireless fidelity (Wi-Fi) system or worldwide interoperability for microwave access (WiMAX) signal transmission, but the disclosure is not limited thereto.

In addition, the processor 114 is coupled to the communication circuit 112, and may be a general-purpose processor, a special-purpose processor, a conventional processor, a digital signal processor, multiple microprocessors, one or more microprocessors combined with a digital signal processor core, a controller, a microcontroller, an Application Specific Integrated Circuit (ASIC), a Field Programmable Gate Array (FPGA), any other kinds of integrated circuits, state machines, Advanced RISC Machine (ARM)-based processors, and the like.

As shown in FIG. 1, the network device 12 includes a communication circuit 122 and a processor 124; for respective possible implementations thereof, referring to the communication circuit 112 and the processor 114, and the details will not be repeated here.

In an embodiment of the present disclosure, the terminal device 11 and the network device 12 may cooperate to implement the method for dynamically switching frequency bands provided by the present disclosure, and the details of which are as follows.

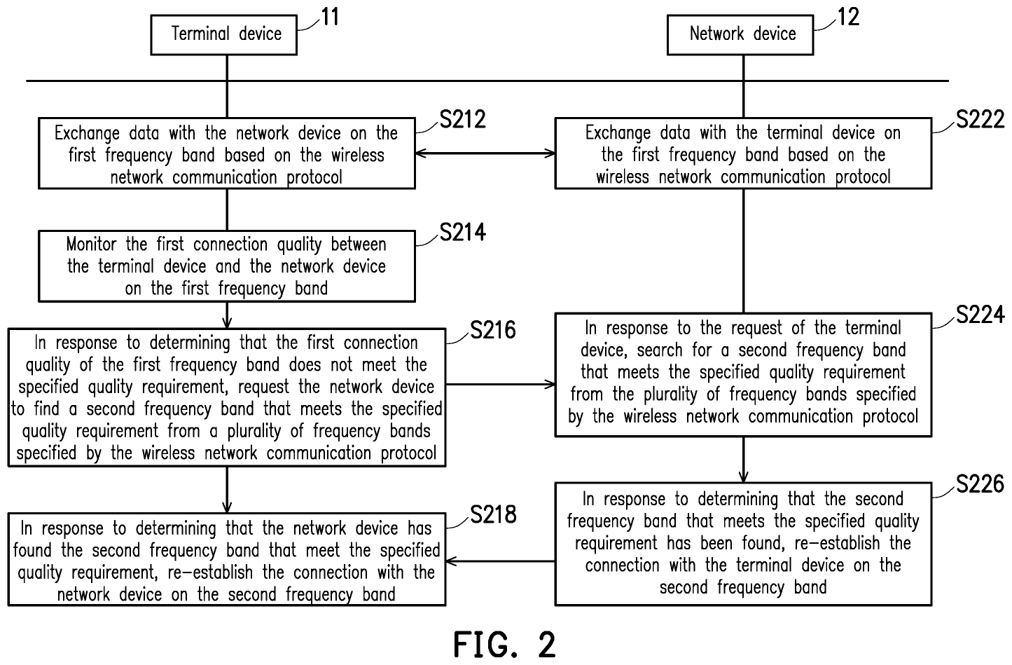

Referring to FIG. 2, which is a flowchart of a method for dynamically switching frequency bands according to an embodiment of the present disclosure. The method of this embodiment may be executed by the terminal device 11 and the network device 12 in FIG. 1, and the details of various steps in FIG. 2 will be described below with the components shown in FIG. 1.

In step S212, the processor 114 of the terminal device 11 exchanges data with the network device 12 on the first frequency band based on the wireless network communication protocol. Correspondingly, in step S222, the processor 122 of the network device 12 exchanges data with the terminal device 11 on the first frequency band based on the wireless network communication protocol.

For ease of description, it is assumed that the wireless network communication protocol considered below is IEEE 802.11ah, which is only adopted as an example, and is not intended to limit possible implementations of the present disclosure.

In an embodiment of the present disclosure, the wireless network communication protocol, for example, may be specified to have multiple corresponding frequency bands. Take IEEE 802.11ah as an example, which may be specified to have multiple frequency bands belonging to Sub-1 GHz, for example, and the first frequency band is, for example, one of the above multiple frequency bands, but the disclosure is not limited thereto.

Next, in step S214, the processor 114 of the terminal device 11 monitors the first connection quality between the terminal device 11 and the network device 12 on the first frequency band. In an embodiment, the processor 114 of the terminal device 11 may determine whether the first connection quality of the first frequency band meets a specified quality requirement.

In different embodiments, the specified quality requirement may be determined according to the designer's needs, and several embodiments are exemplified below for illustration.

In the first embodiment, for example, the processor 114 may control the communication circuit 112 to send a ping command to the network device 12 on the first frequency band, and determine whether the transmission time (for example, the round-trip time) corresponding to the ping command exceeds a first time threshold.

In the first embodiment, the first time threshold may be set as any transmission time sufficient for determining that the first connection quality of the first frequency band is poor according to the designer's requirement, but the disclosure is not limited thereto.

Based on the above, in response to determining that the transmission time corresponding to the ping command exceeds the first time threshold, the processor 114 may determine that the first connection quality of the first frequency band does not meet the specified quality requirement. On the other hand, in response to determining that the transmission time corresponding to the ping command does not exceed the first time threshold, the processor 114 may determine that the first connection quality of the first frequency band meets the specified quality requirement, but the disclosure is not limited thereto.

In the second embodiment, for example, the processor 114 may control the communication circuit 112 to transmit the specific data with a specified size to the network device 12, and determine whether the transmission time for transmitting the specific data exceeds a second time threshold.

In the second embodiment, the second time threshold may be set as any transmission time sufficient for determining that the second connection quality of the first frequency band is poor according to the designer's requirement, but the disclosure is not limited thereto.

Based on the above, in response to determining that the transmission time for transmitting the specific data exceeds the second time threshold, the processor 114 may determine that the first connection quality of the first frequency band does not meet the specified quality requirement. On the other hand, in response to determining that the transmission time for transmitting the specific data does not exceed the second time threshold, the processor 114 may determine that the first connection quality of the first frequency band meets the specified quality requirement, but the disclosure is not limited thereto.

In the third embodiment, the processor 114 may determine whether a received signal strength indication (RSSI) corresponding to the first frequency band is lower than a signal strength threshold.

In the third embodiment, the signal strength threshold may be set as any signal strength indication sufficient for determining that the second connection quality of the first frequency band is poor according to the designer's requirement, but the disclosure is not limited thereto.

Based on the above, in response to determining that the RSSI corresponding to the first frequency band is lower than the signal strength threshold, the processor 114 may determine that the first connection quality of the first frequency band does not meet the specified quality requirement. On the other hand, in response to determining that the RSSI corresponding to the first frequency band is not lower than the signal strength threshold, the processor 114 may determine that the first connection quality of the first frequency band meets the specified quality requirement, but the disclosure is not limited thereto.

In other embodiments, for example, the processor 114 may determine whether the first connection quality of the first frequency band meets the specified quality requirement based on multiple mechanisms described in the first to third embodiments simultaneously.

For example, in the fourth embodiment, the processor 114 may determine that the first connection quality of the first frequency band meets the specified quality requirement only when it is determined that the transmission time corresponding to the ping command does not exceed the first time threshold and the transmission time for transmitting the specific data does not exceed the second time threshold. In other words, in response to determining that the transmission time corresponding to the ping command exceeds the first time threshold, or the transmission time for transmitting the specific data exceeds the second time threshold, the processor 114 may determine that the first connection quality of the first frequency band does not meet the specified quality requirement.

In another example, in the fifth embodiment, the processor 114 may determine that the first connection quality of the first frequency band meets the specified quality requirement only when it is determined that the transmission time for transmitting the specific data does not exceed the second time threshold, and the RSSI corresponding to the first frequency band is not lower than the signal strength threshold. In other words, in response to determining that the transmission time for transmitting the specific data exceeds the second time threshold, or the RSSI corresponding to the first frequency band is lower than the signal strength threshold, the processor 114 may determine that the first connection frequency on the first frequency band does not meet the specified quality requirement.

In the sixth embodiment, the processor 114 may determine that the first connection quality of the first frequency band meets the specified quality requirement only when it is determined that the transmission time corresponding to the ping command does not exceed the first time threshold, the transmission time for transmitting the specific data does not exceed the second time threshold, and the RSSI corresponding to the first frequency band is not lower than the signal strength threshold. In other words, in response to determining that the transmission time corresponding to the ping command exceeds the first time threshold, the transmission time for transmitting the specific data exceeds the second time threshold, or the RSSI corresponding to the first frequency band is lower than the signal strength threshold, the processor 114 may determine that the first connection quality of the first frequency band does not meet the specified quality requirement.

Afterwards, in step S216, in response to determining that the first connection quality of the first frequency band does not meet the specified quality requirement, the processor 114 of the terminal device 11 requests the network device 12 to find a second frequency band that meets the specified quality requirement from a plurality of frequency bands specified by the wireless network communication protocol. Correspondingly, in step S224, in response to the request of the terminal device 11, the processor 124 of the network device 12 searches for a second frequency band that meets the specified quality requirement from the plurality of frequency bands specified by the wireless network communication protocol.

In the case that the considered wireless network communication protocol is assumed to be IEEE 802.11ah, the second frequency band is, for example, another Sub-1 GHz frequency band different from the first frequency band, but the disclosure is not limited thereto.

In an embodiment, the processor 124 of the network device 12 may determine whether a second frequency band that meets the specified quality requirement has been found. For the related principles for making judgment, referring to the related description for determining whether the first frequency band meets the specified quality requirement (such as the first to sixth embodiments), but the disclosure is not be limited thereto.

In an embodiment, in response to determining that the network device 12 does not find the second frequency band that meets the specified quality requirement, the terminal device 11 and the network device 12 may maintain the connection on the first frequency band.

On the other hand, in step S226, in response to determining that the second frequency band that meets the specified quality requirement has been found, the processor 124 of the network device 12 re-establishes the connection with the terminal device 11 on the second frequency band. Correspondingly, in step S218, in response to determining that the network device 12 has found the second frequency band that meets the specified quality requirement, the processor 114 of the terminal device 11 re-establishes the connection with the network device 12 on the second frequency band.

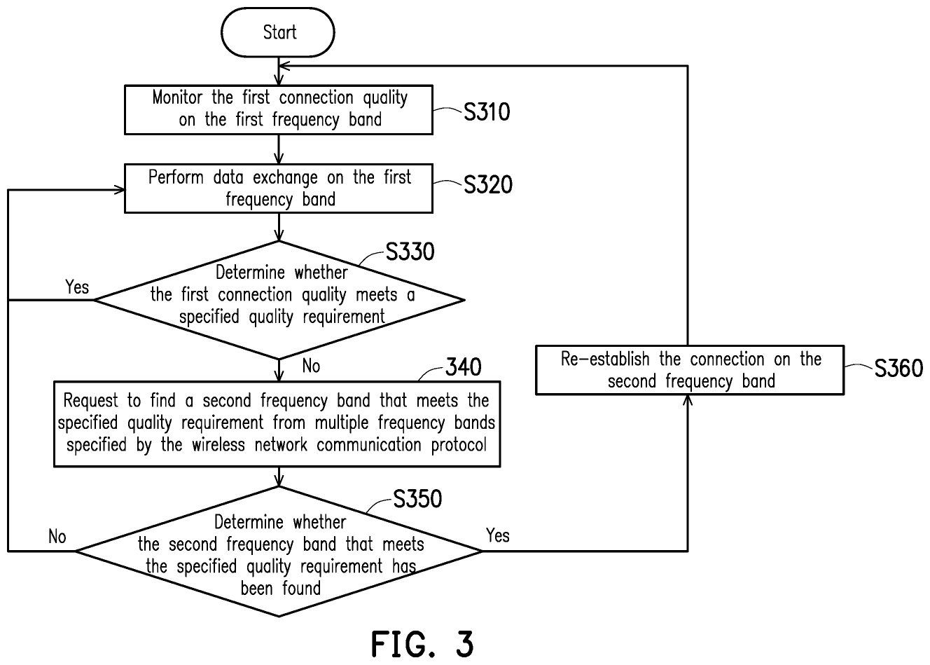

Referring to FIG. 3, which is a flowchart of a method for dynamically switching frequency bands performed by a terminal device according to an embodiment of the present disclosure.

First, the terminal device 11 executes step S310 to monitor the first connection quality on the first frequency band, and executes step S320 to perform data exchange on the first frequency band.

In step S330, the terminal device 11 may determine whether the first connection quality meets a specified quality requirement. In different embodiments, the terminal device 11 may, for example, execute step S320 based on the mechanism described in the above-mentioned first to sixth embodiments, details of which may be derived from the description provided above and will not be repeated here.

In an embodiment, if the first connection quality is determined as meeting the specified quality requirement, the terminal device 11 may return to step S320. On the other hand, if the first connection quality is determined as failing to meet the specified quality requirement, the terminal device 11 may continue to perform step S340 to request to find a second frequency band that meets the specified quality requirement from multiple frequency bands specified by the wireless network communication protocol.

In step S350, the terminal device 11 may determine whether the second frequency band that meets the specified quality requirement has been found. For the related principles for making judgment, referring to the related description for determining whether the first frequency band meets the specified quality requirement (such as the first to sixth embodiments), but the disclosure is not be limited thereto.

In an embodiment, if no second frequency band that meets the specified quality requirement is found, the terminal device 11 may return to step S320. On the other hand, if the second frequency band that meets the specified quality requirement has been found, the terminal device 11 may proceed to step S360 to re-establish the connection on the second frequency band. For details of steps S310 to S360, reference may be made to the description of the embodiments provided above, and details are not repeated here.

To sum up, the method provided in the embodiments of the present disclosure is able to solve the problem of poor transmission quality (such as being interfered) between the terminal device and the network device on the first frequency band (such as a certain Sub-1 GHz frequency band of Wifi HaLow) by dynamically searching for other frequency bands (such as another Sub-1 GHz frequency band of Wifi HaLow) with better transmission quality to establish a new connection. In this way, it is possible to better maintain the communication quality, thereby improving the user's satisfaction with the communication system.

Although the present disclosure has been disclosed above with the embodiments, it is not intended to limit the present disclosure. Those with ordinary knowledge in the technical field may make some modifications and changes without departing from the spirit and scope of the present disclosure. Therefore, the scope to be protected by the present disclosure should be defined by the scope of appended claims.

What is claimed is:

1. A method for dynamically switching frequency bands, which is adaptable for a terminal device and comprises:
monitoring a first connection quality of the terminal device on a first frequency band, wherein the terminal device exchanges data on the first frequency band based on a wireless network communication protocol;
in response to determining that the first connection quality of the first frequency band does not meet a specified quality requirement, requesting to find a second frequency band that meets the specified quality requirement from a plurality of frequency bands specified by the wireless network communication protocol; and
in response to determining that the second frequency band that meets the specified quality requirement has been found, re-establishing a connection on the second frequency band.

2. The method according to claim 1, further comprising:
sending a ping command to a network device on the first frequency band; and
in response to determining that a transmission time corresponding to the ping command exceeds a first time threshold, determining that the first connection quality of the first frequency band does not meet the specified quality requirement.

3. The method according to claim 1, further comprising:
transmitting a specific data with a specified size to a network device;
in response to determining that a transmission time for transmitting the specific data exceeds a second time threshold, determining that the first connection quality of the first frequency band does not meet the specified quality requirement.

4. The method according claim 1, further comprising:
in response to determining that a received signal strength indication (RSSI) corresponding to the first frequency band is lower than a signal strength threshold, determining that the first connection quality of the first frequency band does not meet the specified quality requirement.

5. The method according to claim 1, further comprising:
in response to determining that a network device has found the second frequency band that meets the specified quality requirement, disconnecting a connection between the terminal device and the network device on the first frequency band.

6. The method according to claim 1, further comprising:
in response to determining that a network device does not find the second frequency band that meets the specified quality requirement, maintaining a connection between the terminal device and the network device on the first frequency band.

7. A terminal device, comprising:
a communication circuit; and
a processor, which is coupled to the communication circuit and configured to:
monitor a first connection quality of the terminal device on a first frequency band, wherein the terminal device exchanges data on the first frequency band based on a wireless network communication protocol;
in response to determining that the first connection quality of the first frequency band does not meet a specified quality requirement, request to find a second frequency band that meets the specified quality requirement from a plurality of frequency bands specified by the wireless network communication protocol; and
in response to determining that the second frequency band that meets the specified quality requirement has been found, re-establish a connection on the second frequency band.

8. A method for dynamically switching frequency bands, which is adaptable for a network device and comprises:
exchanging data on a first frequency band based on a wireless network communication protocol;
in response to a request, finding a second frequency band that meets a specified quality requirement from a plurality of frequency bands specified by the wireless network communication protocol; and
in response to determining that the second frequency band that meets the specified quality requirement has been found, re-establishing a connection on the second frequency band.

9. The method according to claim 8, further comprising:
in response to determining that the second frequency band that meets the specified quality requirement has been found, disconnecting a connection between a terminal device and the network device on the first frequency band.

10. The method according to claim 8, further comprising:
in response to determining that the second frequency band that meets the specified quality requirement is not found, maintaining a connection between a terminal device and the network device on the first frequency band.

11. A network device, comprising:
a communication circuit; and
a processor, which is coupled to the communication circuit and configured to:
exchange data on a first frequency band based on a wireless network communication protocol;
in response to a request, find a second frequency band that meets a specified quality requirement from a plurality of frequency bands specified by the wireless network communication protocol; and
in response to determining that the second frequency band that meets the specified quality requirement has been found, re-establish a connection on the second frequency band.
